(19) United States
(12) Patent Application Publication
(10) Pub. No.: US 2024/0427111 A1
(43) Pub. Date: Dec. 26, 2024

(54) DEFOGGING LENS BARREL STRUCTURE

(71) Applicant: Calin Technology Co., Ltd., Taichung City (TW)

(72) Inventors: HSIN-HAN LIN, Taichung City (TW); SUNG-CHIH WU, Taichung City (TW)

(73) Assignee: Calin Technology Co., Ltd., Taichung City (TW)

(21) Appl. No.: 18/374,362

(22) Filed: Sep. 28, 2023

(30) Foreign Application Priority Data
Jun. 21, 2023 (TW) 112123492

(51) Int. Cl. G02B 7/02; G03B 17/55; H04N 23/52

(52) U.S. Cl. CPC G02B 7/028; G03B 17/55; H04N 23/52

(57) ABSTRACT

A defogging lens barrel structure includes a lens barrel, a lens assembly, a heating module, a temperature-sensing module, and a thermal insulating material. The lens barrel has a receiving groove. An inner portion of the receiving groove includes an abutting surface and a recess disposed on the abutting surface. The lens assembly is disposed inside the lens barrel and includes a first lens disposed in the receiving groove. The first lens has a lens abutting surface correspondingly facing the abutting surface. The heating module is disposed between the abutting surface of the lens barrel and the lens abutting surface of the first lens and is adapted to provide a heat source. The temperature-sensing module is engaged with the heating module and is received in the recess of the lens barrel. The thermal insulating material encloses around the temperature-sensing module to be filled into the recess.

### BACKGROUND OF THE INVENTION

### Technical Field

The present invention generally relates to a lens barrel structure, and more particularly to a defogging lens barrel structure.

### Description of Related Art

Generally, when a conventional lens is used in an external environment, a chamber inside the lens has moisture. When an ambient temperature (i.e., a temperature outside the lens) is decreased, moisture outside the lens is easily saturated to condense and form water droplets, so that fog is generated in the lens, thereby affecting a transmittance of the lens.

In order to resolve the fogging problem of the conventional lens, there are few defogging lenses. For example, the China invention patent publication No. CN113126395A discloses a defogging lens including a lens barrel, at least one lens, and a heating member, wherein the at least one lens is disposed in the lens barrel: the heating member includes a heating lens and a power line, wherein the heating lens is disposed on the at least one lens, and the power line passes through the lens barrel to be connected to the heating lens, so that the heating lens could generate a thermal energy to prevent the formation of fog or water droplets.

However, the aforementioned defogging lens has drawbacks. For example, the heating lens directly abuts against an inner wall of the lens barrel: when the heating lens performs heating, the thermal energy of the heating lens is partially dispersed to the lens barrel due to the heating lens being in contact with the lens barrel, so that the entire heating lens cannot be evenly heated: as a result, the fogging problem will still be resulted when the heating lens is used under extremely cold environment.

Additionally, in order to enhance the structural strength of the lens barrel and an outer cover, the lens barrel and the outer cover are typically made of metal: however, metal has a high thermal conductivity: when the heating lens is in contact with the lens barrel and the outer cover, the thermal energy of the heating lens is easily dispersed to the lens barrel and the outer cover, thereby reducing the heating efficiency of the heating lens.

Therefore, how to provide a lens which could resolve the fogging problem of the lens, is a problem needed to be solved in the industry.

### BRIEF SUMMARY OF THE INVENTION

In view of the reasons mentioned above, the primary objective of the present invention is to provide a defogging lens barrel structure, which could effectively reduce the effect of a thermal energy of a lens assembly being dispersed to a lens barrel and hence resolve the fogging problem of the lens assembly of a lens.

The present invention provides a defogging lens barrel structure including a lens barrel, a lens assembly, a heating module, a temperature-sensing module, and a thermal insulating material. The lens barrel has a receiving groove, wherein an inner portion of the receiving groove includes an abutting surface and a recess disposed on the abutting surface. The lens assembly is disposed in the lens barrel and includes a first lens, wherein the first lens is disposed in the receiving groove and has a lens abutting surface correspondingly facing the abutting surface. The heating module is disposed between the abutting surface of the lens barrel and the lens abutting surface of the first lens and is adapted to provide a heat source. The temperature-sensing module is engaged with the heating module and is received in the recess of the lens barrel. The thermal insulating material encloses around the temperature-sensing module to be filled into the recess. The thermal insulating material is a solid material, a gel layer, or a liquid material. A thermal conductivity coefficient of the thermal insulating material is less than or equal to 0.1 W/m.K.

In an embodiment, an axis is defined on the lens barrel. The lens barrel has an object-side opening communicating with the receiving groove along the axis. The abutting surface faces the object-side opening and is located on a bottom of the receiving groove. The first lens includes a peripheral portion, wherein a side of the peripheral portion has the lens abutting surface and is disposed on the abutting surface.

In an embodiment, the recess includes a receiving hole facing the object-side opening and arranged on the abutting surface around the axis.

In an embodiment, the recess includes a plurality of receiving holes respectively facing the object-side opening and arranged at intervals on the abutting surface around the axis: the recess forms a separating block between adjacent two of the plurality of receiving holes.

In an embodiment, the heating module includes an electro-thermal heater correspondingly disposed on the abutting surface of the receiving groove around the axis and covering the recess: the lens abutting surface of the first lens abuts against the electro thermal heater: the electro-thermal heater is connected to the external power source through a conducting wire to provide the heat source to the first lens.

In an embodiment, the lens barrel includes a side opening passing through the receiving groove, connected to the object-side opening, and adapted to be passed through by the conducting wire for being connected to the electro-thermal heater and to guide the conducting wire out of the lens barrel.

In an embodiment, the temperature-sensing module includes at least one thermister sensor engaged with the electro-thermal heater and received in the recess; the thermal insulating material is filled into the recess and is in contact with the at least one thermister sensor and the electro-thermal heater.

In an embodiment, when the thermal insulating material is the solid material, the thermal insulating material has at least one hole adapted to receive the at least one thermister sensor in the thermal insulating material.

In an embodiment, the receiving hole includes a large-diameter section and a small-diameter section: the large-diameter section is connected to the abutting surface: the small-diameter section is away from the abutting surface and is connected to the large-diameter section: the temperature-sensing module is correspondingly disposed in the large-diameter section; the thermal insulating material is correspondingly filled into the large-diameter section and the small-diameter section.

In an embodiment, the inner portion of the receiving groove includes an inside wall connected to the abutting surface and the object-side opening: a thermal insulating portion is provided on the inside wall: the peripheral portion has an annular peripheral surface connected to the lens abutting surface and correspondingly facing the inside wall: the thermal insulating portion is in contact between the inside wall and the annular peripheral surface.

In an embodiment, the defogging lens barrel structure further includes a lens cover fitting around the lens barrel; an end of the lens cover has a blocking ring partially covering the object-side opening: a side of the blocking ring facing the object-side opening has a thermal insulating ring: when an object-side surface of the first lens protrudes out of the object-side opening, the thermal insulating ring abuts against the object-side surface to be fixed between the object-side surface and the blocking ring.

With the aforementioned design of the defogging lens barrel structure, the receiving groove of the lens barrel has the recess correspondingly disposed on the abutting surface and adapted to be filled by the thermal insulating material, the temperature-sensing module is engaged with the heating module and is received in the recess, and the thermal insulating material encloses around the temperature-sensing module. When the heating module is actually activated to perform heating, the thermal insulating material prevent the gap between the temperature-sensing module and the inner wall of the recess, so that the heat transfer of the heating module in the recess due to heat convection and heat radiation is reduced and the effect of the thermal energy of the heating module being dispersed to the lens barrel is reduced, thereby improving the heating efficiency of the heating module concentrated on the first lens. Thus, the entire first lens is evenly heated, so that fog generated in the first lens is relatively reduced and the definition of the image captured by the lens assembly is improved. Hence, the defogging lens barrel structure could be used in various environments without being limited by the change of climate temperature difference.

Additionally, even if the lens barrel and the lens cover are made of metal, the contact of the first lens with the lens barrel and the lens cover is effectively prevented by the thermal insulating material, the thermal insulating portion, and the thermal insulating ring, so that the effect of the thermal energy of the first lens being dispersed is effectively reduced and the heating module could concentratedly heat the first lens, thereby improving the defogging effect.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the defogging lens barrel structure according to a first embodiment of the present invention;

FIG. 2 is an exploded view of the defogging lens barrel structure according to the first embodiment of the present invention:

FIG. 3 is a perspective view of the lens barrel of the defogging lens barrel structure according to the first embodiment of the present invention:

FIG. 4 is a top view of the lens barrel of the defogging lens barrel structure according to the first embodiment of the present invention;

FIG. 5 is a sectional schematic view of the lens barrel of the defogging lens barrel structure according to the first embodiment of the present invention:

FIG. 6 is a sectional schematic view of the defogging lens barrel structure according to the first embodiment of the present invention:

FIG. 7 is a partially enlarged view of FIG. 6, showing a top portion of the defogging lens barrel structure according to the first embodiment of the present invention:

FIG. 8 is a schematic view of the thermal insulating portion and the thermal insulating ring of the defogging lens barrel structure according to the first embodiment of the present invention:

FIG. 9 is an exploded view of the defogging lens barrel structure according to a second embodiment of the present invention:

FIG. 10 is a perspective view of the lens barrel of the defogging lens barrel structure according to the second embodiment of the present invention:

FIG. 11 is a top view of the lens barrel of the defogging lens barrel structure according to the second embodiment of the present invention:

FIG. 12 is a sectional schematic view of the defogging lens barrel structure according to the second embodiment of the present invention:

FIG. 13 is a partially enlarged view of FIG. 12, showing a top portion of the defogging lens barrel structure according to the second embodiment of the present invention:

FIG. 14A is a schematic view showing a temperature distribution of the defogging lens barrel structure of the control group at the heated state; and

FIG. 14B is a schematic view showing a temperature distribution of the defogging lens barrel structure of the experimental group at the heated state.

### DETAILED DESCRIPTION OF THE INVENTION

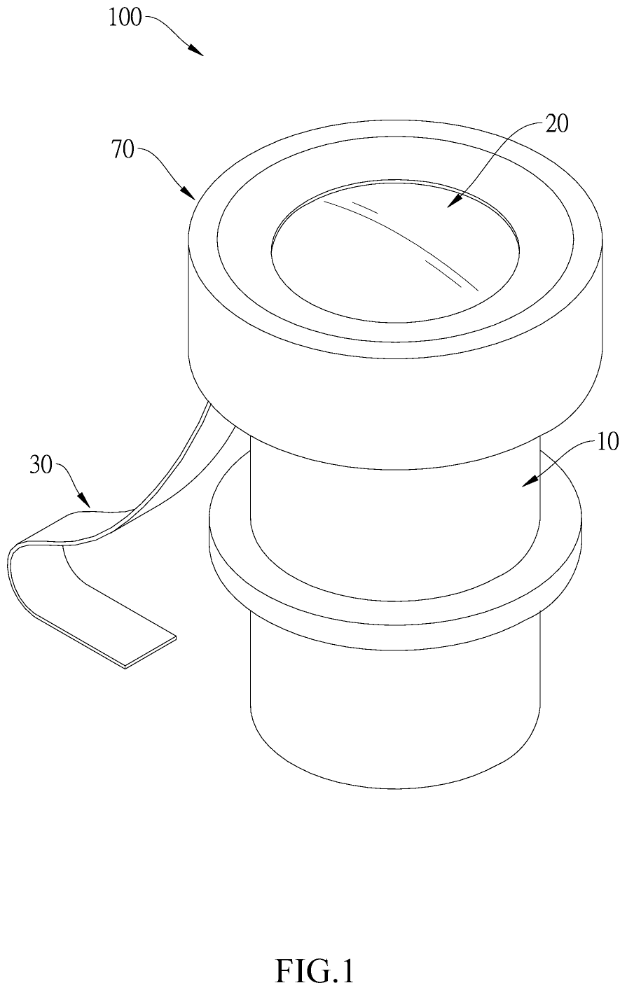

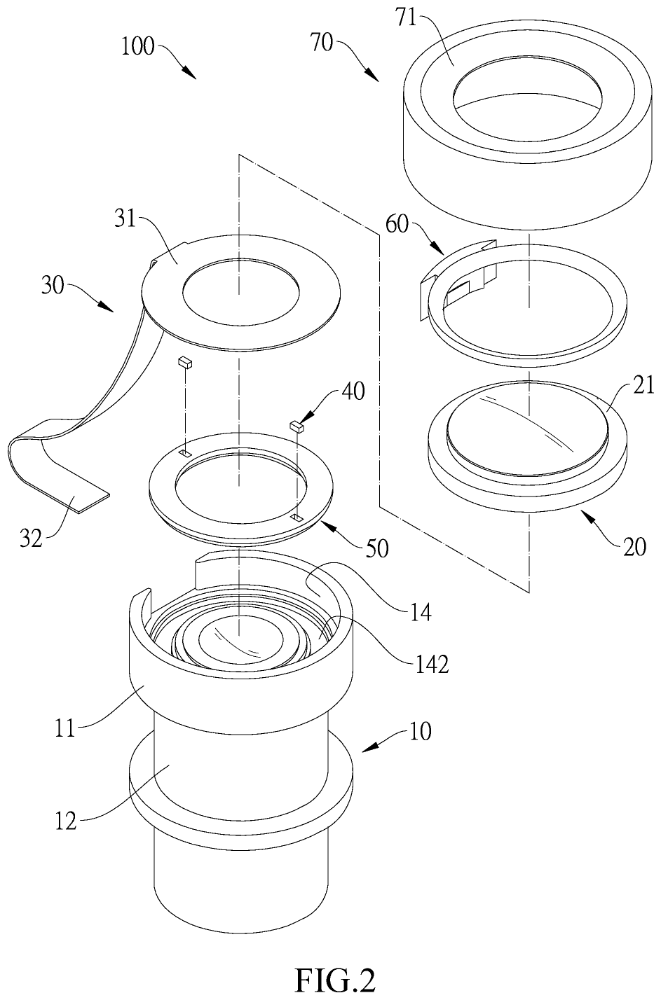

A defogging lens barrel structure 100 according to a first embodiment of the present invention is illustrated in FIG. 1 to FIG. 2 and basically includes a lens barrel 10, a lens assembly 20, heating module 30, a temperature-sensing module 40, a thermal insulating material 50, a lens restricting member 60, and a lens cover 70.

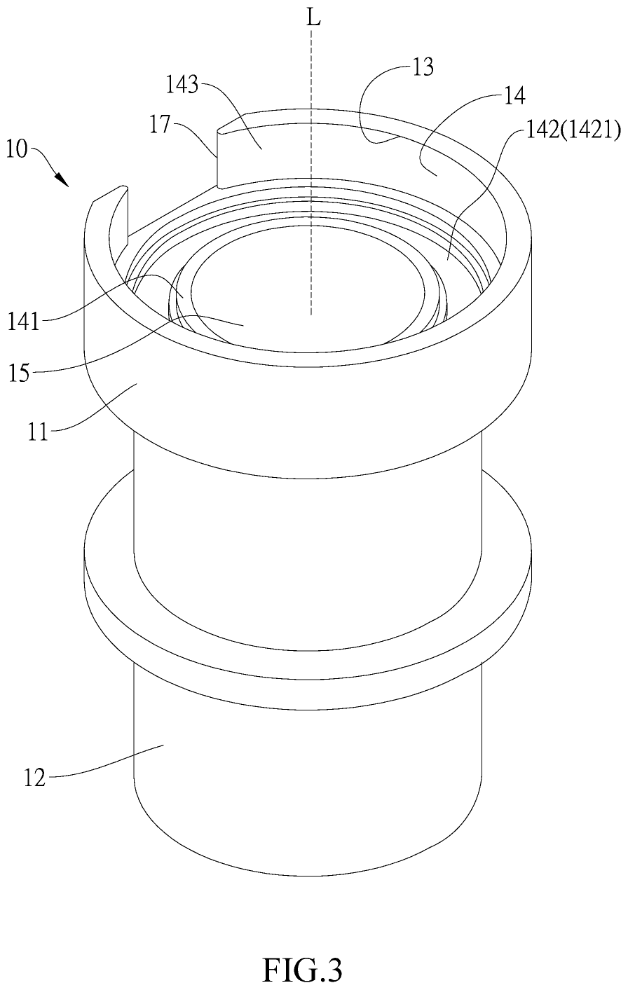

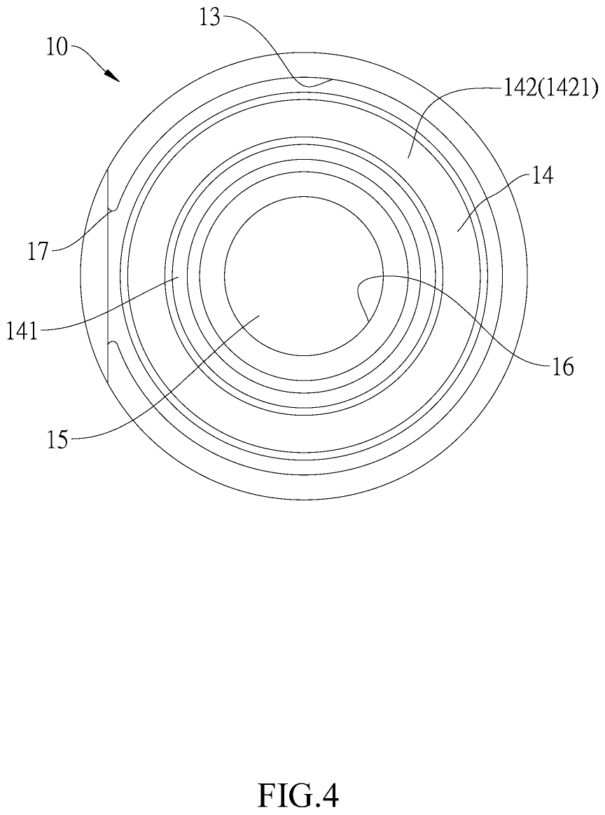

The entire lens barrel 10 is a straight hollow tube. As shown in FIG. 3 and FIG. 4, an axis L is defined on the lens barrel 10. The lens barrel 10 includes a head 11 and a body 12, wherein the head 11 and the body 12 are formed as a monolithic unit along the axis L. As shown in FIG. 3 to FIG. 5, an inner portion of the lens barrel 10 further includes an object-side opening 13, a receiving groove 14, a slot 15, and an image-side opening 16 along the axis. The object-side opening 13 is located on an end of the head 11. The receiving groove 14 is disposed on an inside of the head 11 and communicates with the object-side opening 13. The slot 15 penetrates through an inner portion of the body 12 and communicates with the receiving groove 14. The image-side opening 16 is opposite to the object-side opening 13 and communicates with an end of the slot 15 located on the body 12. Additionally, referring to FIG. 3 and FIG. 4, the lens barrel 10 further includes a side opening 17 penetrating through a side of the receiving groove 14 and connected to the object-side opening 13.

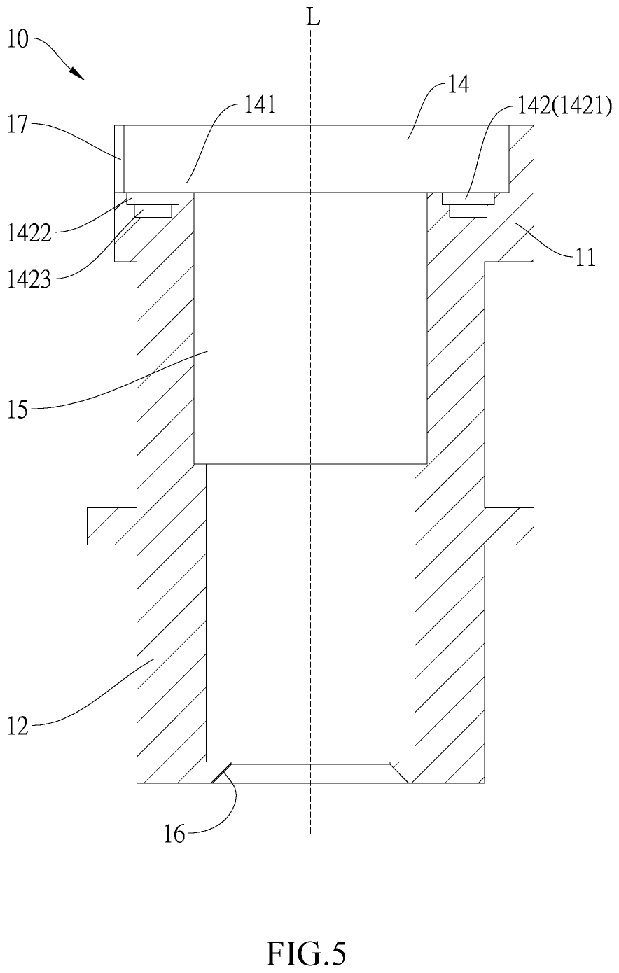

An inner portion of the receiving groove 14 includes an abutting surface 141, a recess 142, and an inside wall 143. In the current embodiment, the abutting surface 141 faces the object-side opening 13 and is located on a bottom of the receiving groove 14; the recess 142 is disposed on the abutting surface 141; the inside wall 143 is connected to the abutting surface 141 and the object-side opening 13. As shown in FIG. 4 and FIG. 5, the recess 142 includes a receiving hole 1421 arranged on the abutting surface 141 around the axis L, wherein an inner portion of the receiving hole 1421 includes a large-diameter section 1422 and a small-diameter section 1423. The large-diameter section 1422 is connected to the abutting surface 141. The small-diameter section 1423 is away from the abutting surface 141 and is connected to the large-diameter section 1422.

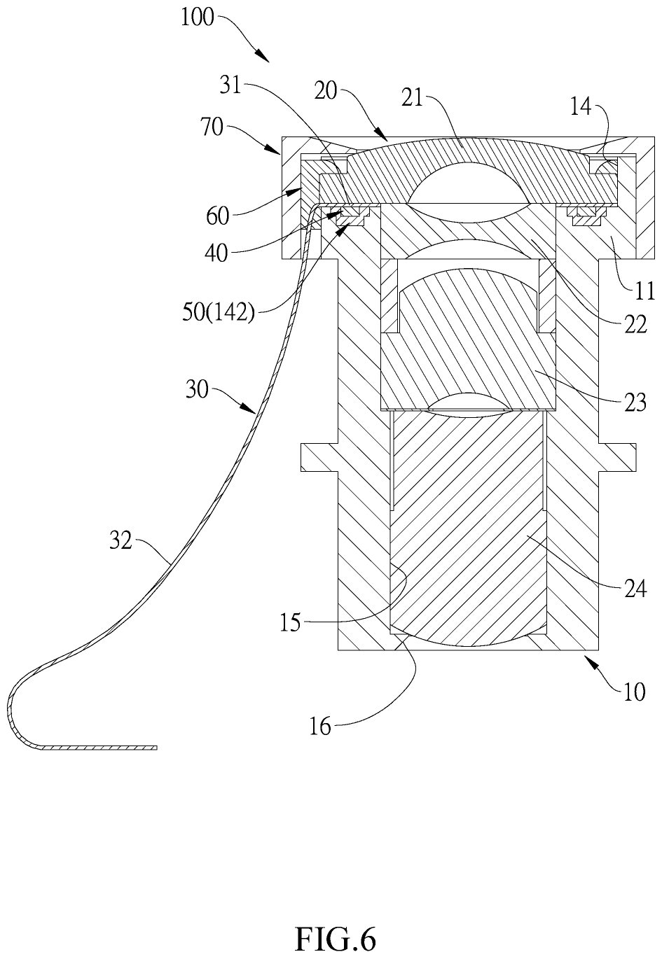

The lens assembly 20 is disposed inside the lens barrel 10 and includes a first lens 21, wherein the first lens 21 is disposed in the receiving groove 14 of the head 11. As shown in FIG. 2, FIG. 6, and FIG. 6, the first lens 21 includes a peripheral portion 211 disposed on the abutting surface 141, wherein a bottom side of the peripheral portion 211 has a lens abutting surface 212. The lens abutting surface 212 correspondingly faces the abutting surface 141. A periphery of the peripheral portion 211 has an annular peripheral surface 213 connected to the lens abutting surface 212 and correspondingly facing the inside wall 143. Additionally, in the current embodiment, lens assembly 20 further includes a second lens 22, a third lens 23, and a fourth lens 24 that are disposed in order in the slot 15 of the body 12 along the axis L, wherein the fourth lens 24 is close to the image-side opening 16.

In other embodiments, a position of the abutting surface 141 of the receiving groove 14 and the number and the shape of the receiving hole 1421 of the recess 142 could be adjusted based on the demand: for example, the inside wall 143 of the receiving groove 14 could be omitted, the abutting surface 141 is provided on a side wall of the receiving groove 14, and the lens abutting surface 212 of the first lens 21 correspondingly faces the abutting surface 141; the receiving hole 1421 of the recess 142 could be in any geometric shape: the large-diameter section 1422 and the small-diameter section 1423 of the receiving hole 1421 could be omitted: the number of the receiving hole 1421 of the recess 142 could be plural based on the demand, as long as the recess 142 is disposed on the abutting surface 141; additionally, the number of the lens of the lens assembly 20 could be adjusted based on the demand, or the second lens 22, the third lens 23, and the fourth lens 24 could be omitted, as long as the first lens 21 is as least provided.

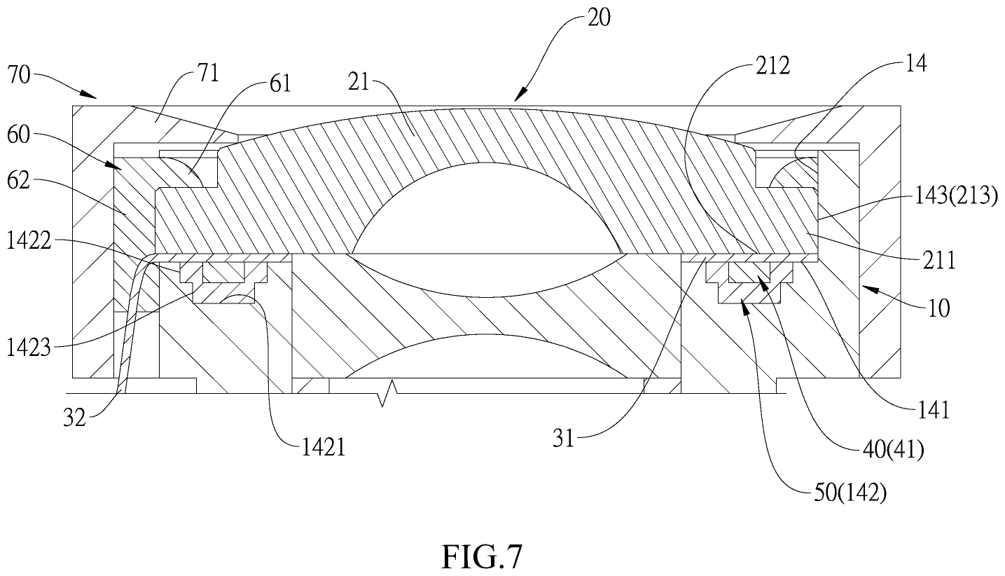

The heating module 30 is disposed between the abutting surface 141 of the lens barrel 10 and the lens abutting surface 212 of the first lens 21 and is adapted to provide a heat source. Referring to FIG. 2, FIG. 6, and FIG. 7, in the current embodiment, the heating module 30 includes an electro-thermal heater 31 and a conducting wire 32. The electro-thermal heater 31 is correspondingly disposed on the abutting surface 141 of the receiving groove 14 around the axis L and covers the recess 142. The lens abutting surface 212 of the first lens 21 abuts against the electro-thermal heater 31. The conducting wire 32 is connected to the electro-thermal heater 31. With the side opening 17 of the lens barrel 10, the conducting wire 32 is guided to an outside of the lens barrel 10 by the side opening 17 of the lens barrel 10 without damaging the abutting surface 141 and the recess 142. The electro-thermal heater 31 is connected to an external power source through the conducting wire 32, so that the electro-thermal heater 31 heats the first lens 21.

The temperature-sensing module 40 is engaged with the heating module 30 and is received in the recess 142 of the lens barrel 10. Referring to FIG. 6 and FIG. 7, in the current embodiment, the temperature-sensing module 40 includes a plurality of thermister sensors 41, wherein each of the thermister sensors 41 is a negative temperature coefficient (NTC) thermister that a resistance of the NTC thermister decreases as temperature increases and is suitable for sensing temperature. The thermister sensors 41 are engaged with the electro-thermal heater 31, are received in the receiving hole 1421 of the recess 142, and are adapted to sense a temperature of the lens barrel 10 affected by an external environment. When the thermister sensors 41 are received in the receiving hole 1421 of the recess 142, the thermister sensor 41 are relatively disposed in the large-diameter section 1422, wherein a gap is reserved between the large-diameter section 1422 and a periphery of the thermister sensors 41. In this way, when the heating module 30 is actually activated to perform heating, the thermister sensors 41 are connected to the electro-thermal heater 31 and a peripheral surface of the thermister sensors 41 is not in contact with an inner wall of the recess 142, so that a thermal energy generated by the electro-thermal heater 31 could not be directly transferred to the lens barrel 10 through the thermister sensor 41, thereby reducing the effect of the thermal energy of the heating module 30 being dispersed.

In other embodiments, the number of the temperature-sensing module 40 could be adjusted based on the demand, as long as the number of the thermister sensor 41 of the temperature-sensing module 40 is at least one, which could also sense the temperature of the lens barrel 10; the temperature-sensing module 40 could be changed to other temperature sensors.

The thermal insulating material 50 encloses around the temperature-sensing module 40 to be filled into the recess 142. The thermal insulating material 50 is a solid material (such as asbestos and glass fibers), a gel layer, or a liquid material, and a thermal conductivity coefficient of the thermal insulating material 50 is less than or equal to 0.1 W/m.K for preventing the thermal energy of the heating module 30 from being dispersed to the lens barrel 10. It is worth mentioning that in the current embodiment, the thermal insulating material 50 does not includes gas (air); although the gas has low heat conduction efficiency, the gas does not prevent the gap formed between the temperature-sensing module 40 and the inner wall of the recess 142; as a result, when the heating module 30 actually performs heating, the thermal energy of the heating module 30 could be dispersed to the lens barrel 10 through heat convection and heat radiation, so that the heating efficiency of the first lens 21 is reduced. In the current embodiment, the thermal insulating material 50 is a solid material, a gel layer, or a liquid material to substantially prevent the gap formed between the temperature-sensing module 40 and the inner wall of the recess 142, so that the heat transfer of the heating module 30 in the recess 142 due to heat convection and heat radiation is relatively reduced, thereby reducing the effect of the thermal energy of the heating module 30 being dispersed to the lens barrel 10.

Referring to FIG. 2, FIG. 6, and FIG. 7, in the current embodiment, when the thermal insulating material 50 makes use of the solid material and is correspondingly filled into the large-diameter section 1422 and the small-diameter section 1423 of the receiving hole 1421, the thermal insulating material 50 has a plurality of holes 51 adapted to correspondingly receive the thermister sensors 41 in the thermal insulating material 50, so that the thermal insulating material 50 encloses a peripheral surface of the thermister sensors 41 and is in contact with the thermister sensors 41 and the electro-thermal heater 31. In this way, the thermal insulating material 50 prevents the thermister sensors 41 from being in contact with the inner wall of the recess 142, so that the effect of the thermal energy of the heating module 30 being dispersed to the lens barrel 10 is reduced and the heating efficiency of the heating module 30 concentrated on the first lens 21 is increased to evenly heat the entire first lens 21, thereby achieving the purpose of removing fog generated in the first lens 21.

The lens restricting member 60 is disposed in the receiving groove 14 of the lens barrel 10 and is fixed on the first lens 21. The lens restricting member 60 includes an annular fixing base 61 and a restricting block 62, wherein the annular fixing base 61 correspondingly abuts against the peripheral portion 211 of the first lens 21. The restricting block 62 is engaged with a side of the annular fixing base 61 and extends out of the side opening 17 of the lens barrel 10, wherein two sides of the restricting block 62 respectively abuts against two wall surfaces of the side opening 17 (not shown) The restricting block 62 fixes a portion of the annular peripheral surface 213 of the peripheral portion 211 and an outer edge of the lens barrel 10, so that the first lens 21 is positioned in the receiving groove 14 of the lens barrel 10. The restricting block 62 further has a guiding hole adapted to be passed through by the conducting wire 32 from the side opening 17, so that the conducting wire 32 could be guided to pass out of the lens barrel 10.

In other embodiments, the structure of the lens restricting member 60 could be adjusted based on the demand and is not limited to include the annular fixing base 61 and the restricting block 62, as long as the first lens 21 could be restricted: the lens restricting member 60 could also be omitted, and the first lens 21 is fixed in the receiving groove 14 of the lens barrel 10.

The lens cover 70 fits around an outer edge of the head 11 of the lens barrel 10. As shown in FIG. 6 and FIG. 7, an end of the lens cover 70 has a blocking ring 71, wherein the blocking ring 71 partially covers the object-side opening 13. When the first lens 21 is received in the receiving groove 14, an object-side surface 214 of the first lens 21 protrudes out of the object-side opening 13, so that the blocking ring 71 could abut against the object-side surface 214 of the first lens 21, thereby enhancing the effect of restricting the first lens 21 in the receiving groove 14.

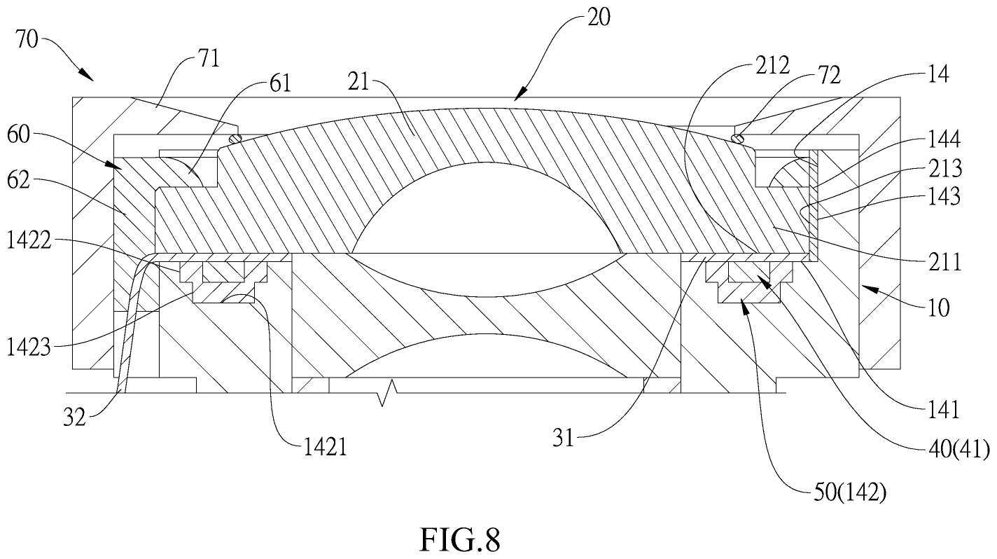

Additionally, referring to FIG. 8, in other embodiments, the inner portion of the receiving groove 14 has a thermal insulating portion 144 on the inside wall 143. When the peripheral portion 211 of the first lens 21 is disposed above the abutting surface 141, the annular peripheral surface 213 of the peripheral portion 211 is in contact with the thermal insulating portion 144, so that the thermal insulating portion 144 is in contact between the inside wall 143 and the annular peripheral surface 213, thereby preventing the first lens 21 from being in contact with the inside wall 143 of the lens barrel 10 by the thermal insulating portion 144. Moreover, a side of the blocking ring 71 of the lens cover 70 facing the object-side opening 13 of the lens barrel 10 has a thermal insulating ring 72. When the lens cover 70 fits around the head 11 of the lens barrel 10, the thermal insulating ring 72 abuts against the object-side surface 214 of the first lens 21 to be fixed between the object-side surface 214 and the blocking ring 71, so that the contact of the first lens 21 with the lens cover 70 is prevented by the thermal insulating ring 72. In this way, even if the lens barrel 10 and the lens cover 70 are made of metal and when the first lens 21 is heated due to the heating module 30, the contact of the first lens 21 with the lens barrel 10 and the lens cover 70 could be effectively prevented by the thermal insulating material 50, the thermal insulating portion 144, and the thermal insulating ring 72, so that the effect of the thermal energy of the first lens 21 being dispersed to the lens barrel 10 and the lens cover 70 is effectively reduced and the heating module 30 could concentratedly heat the first lens 21, thereby reducing fogging of the first lens 21 and improving a definition of an image captured by the lens assembly 20.

With the aforementioned design of the defogging lens barrel structure 100 of the first embodiment, the receiving groove 14 of the lens barrel 10 has the recess 142 correspondingly disposed on the abutting surface 141 and adapted to be filled by the thermal insulating material 50, the temperature-sensing module 40 is engaged with the heating module 30 and is received in the recess 142, and the thermal insulating material 50 encloses around the temperature-sensing module 40. In this way, when the heating module 30 is actually activated to perform heating, the thermal insulating material 50 prevents the contact between the temperature-sensing module 40 and the inner wall of the recess 142, so that the thermal energy of the heating module 30 being dispersed to gaps of the lens barrel 10 could be effectively reduced and the heat transfer of the heating module 30 in the recess 142 due to heat convection and heat radiation could be reduced, thereby improving the heating efficiency of the heating module 30 concentrated on the first lens 21. Thus, the entire first lens 21 is evenly heated, so that fog generated in the first lens 21 is relatively reduced and the definition of the image captured by the lens assembly 20 is improved. Hence, the defogging lens barrel structure 100 could be used in various environments without being limited by the change of climate temperature difference.

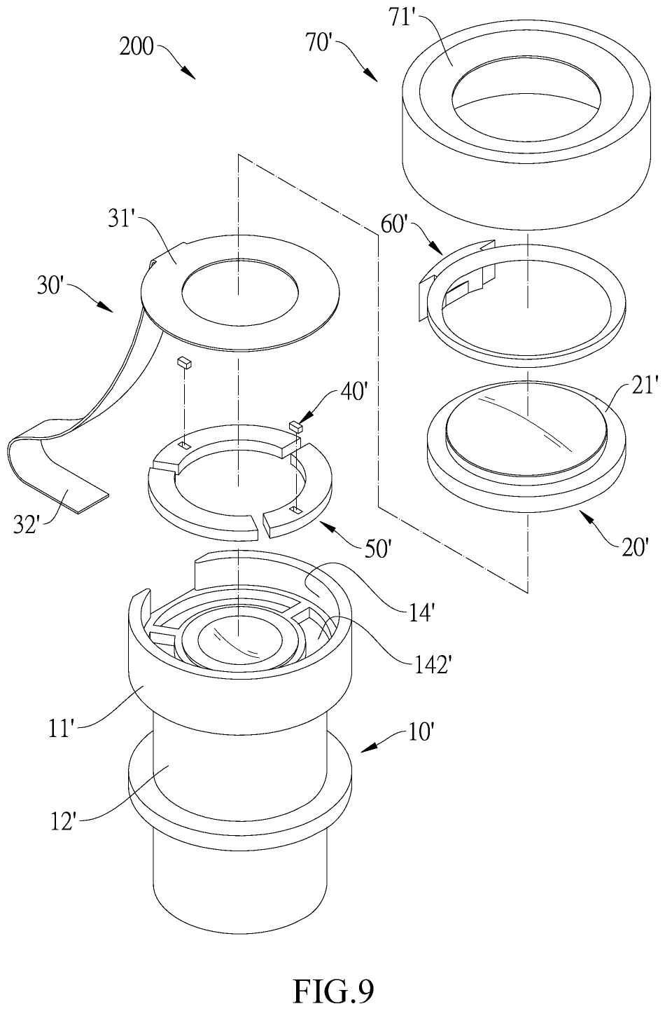

A defogging lens barrel structure 200 according to a second embodiment of the present invention is illustrated in FIG. 9 to FIG. 13 and basically includes a lens barrel 10′, a lens assembly 20′, a heating module 30′, a temperature-sensing module 40′, a thermal insulating material 50′, a lens restricting member 60′, and a lens cover 70′.

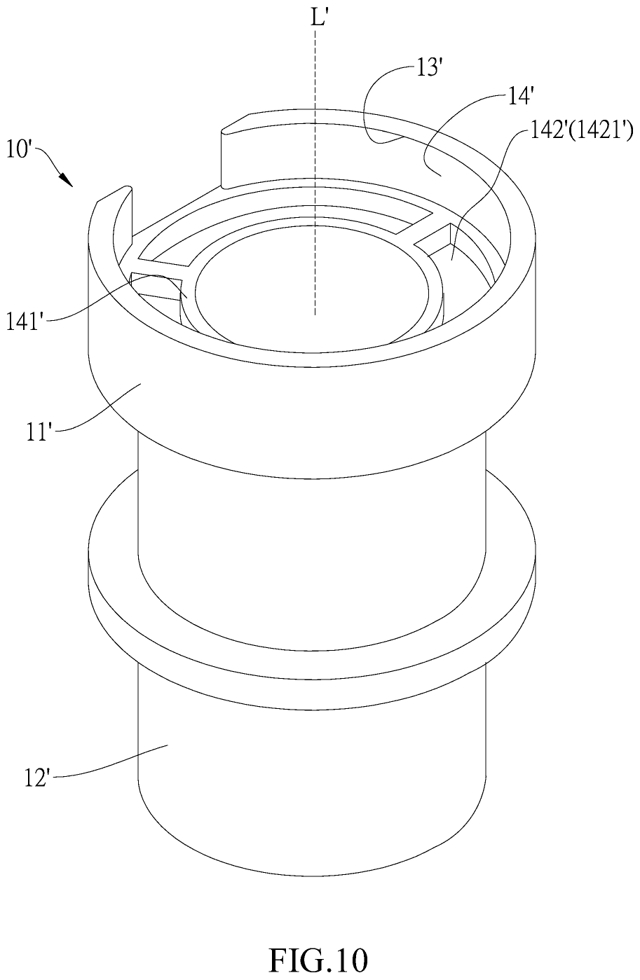

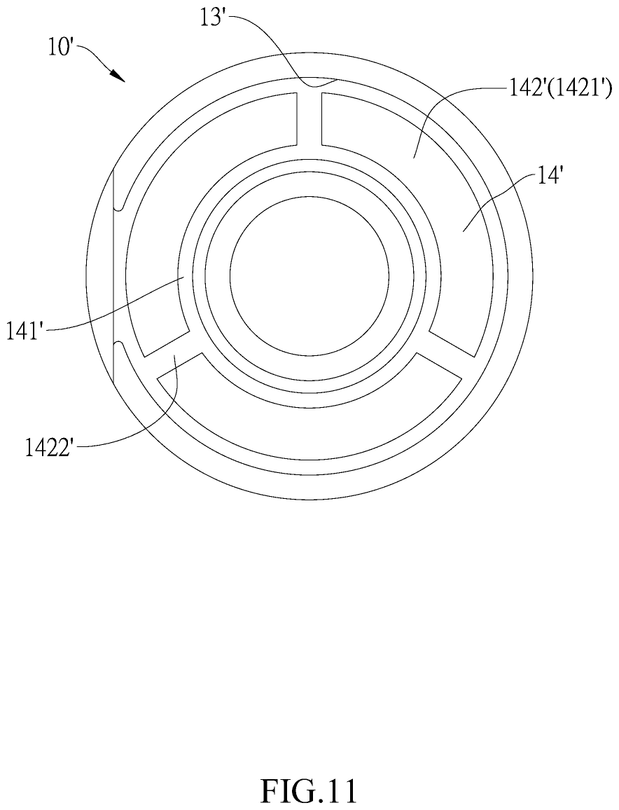

Referring to FIG. 10 and FIG. 11, the structure of the lens barrel 10′ of the second embodiment is similar to the structure of the lens barrel 10 of the first embodiment. An axis L′ is defined on the lens barrel 10′. The lens barrel 10′ includes a head 11′ and a body 12′, where the head 11′ and the body 12′ are formed as a monolithic unit. An inner portion of the lens barrel 10′ includes an object-side opening 13′ and a receiving groove 14′ along the axis L′, wherein the object-side opening 13′ is located on an end of the head 11′. The receiving groove 14′ is disposed on an inside the head 11′ and communicates with the object-side opening 13′. An inner portion of the receiving groove 14′ includes an abutting surface 141′ and a recess 142′, wherein the abutting surface 141′ faces the object-side opening 13′ and is located on a bottom of the receiving groove 14′. The recess 142′ is disposed on the abutting surface 141′. Referring to FIG. 10 and FIG. 11, in the second embodiment, the recess 142′ includes three receiving holes 1421′ arranged at intervals on the abutting surface 141′ around the axis L′, wherein a sectional surface of each of the receiving holes 1421′ is a rectangular recess, but not limited thereto; each of the receiving holes 1421′ could also include the large-diameter section 1422 and the small-diameter section 1423 as illustrated in the first embodiment. The recess 142′ forms a separating block 1422′ between adjacent two of the receiving holes 1421′.

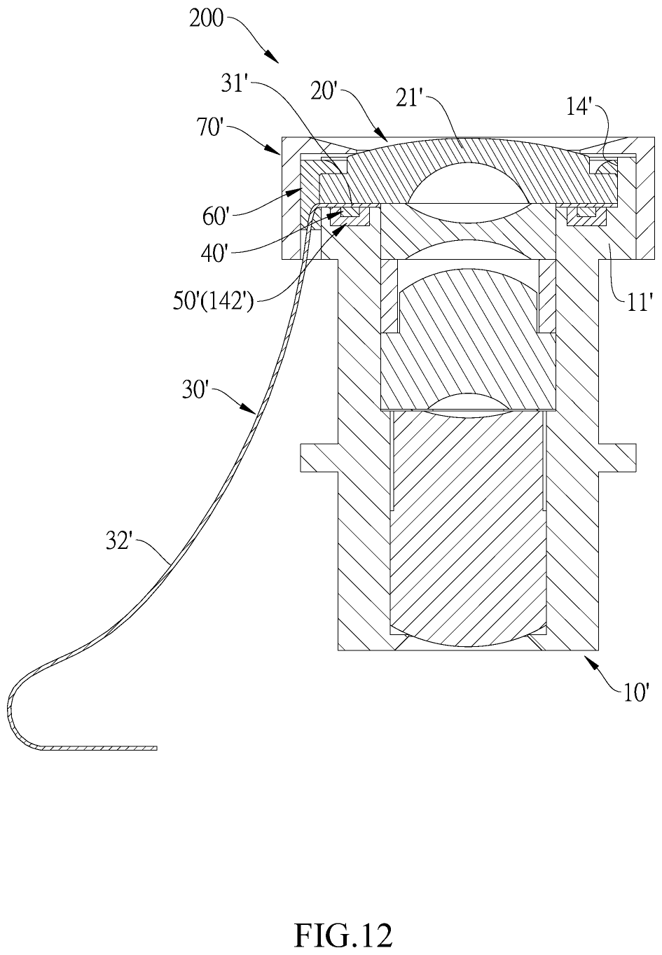

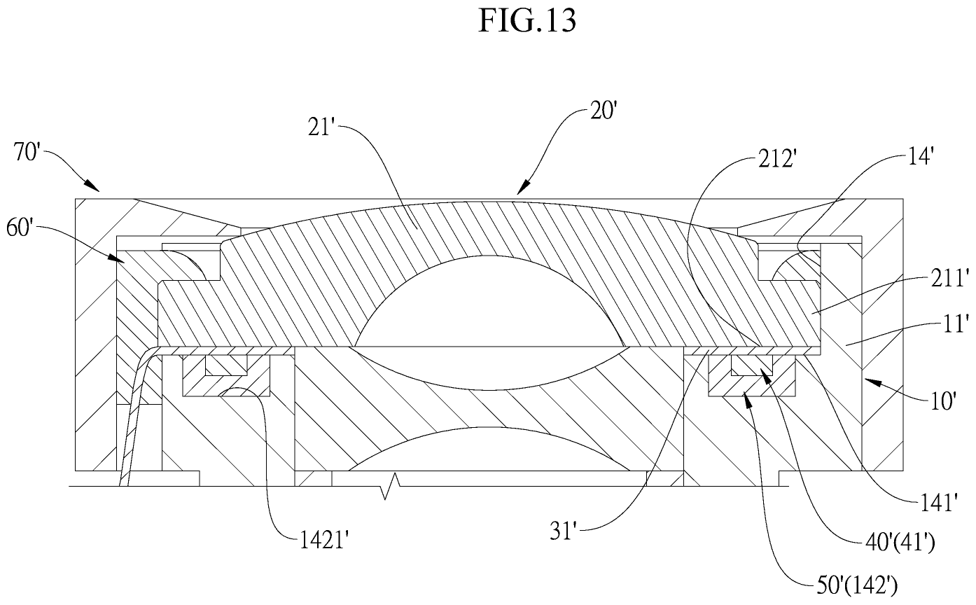

The lens assembly 20′ is disposed inside the lens barrel 10′ and includes a first lens 21′, wherein the first lens 21′ is disposed in the receiving groove 14′ of the head 11′. As shown in FIG. 12 and FIG. 13, the first lens 21′ includes a peripheral portion 211′ disposed on the abutting surface 141′, wherein a bottom side of the peripheral portion 211′ has a lens abutting surface 212′. The lens abutting surface 212′ correspondingly faces the abutting surface 141′.

The heating module 30′ is disposed between the abutting surface 141′ of the lens barrel 10′ and the lens abutting surface 212′ of the first lens 21′ and is adapted to provide a heat source. Referring to FIG. 12 and FIG. 13, in the current embodiment, the heating module 30′ includes an electro-thermal heater 31′ and a conducting wire 32″, wherein the structure of the electro-thermal heater 31′ and the structure of the conducting wire 32′ are the same as that of the first embodiment. The electro-thermal heater 31′ is connected to an external power source through the conducting wire 32′, so that the electro-thermal heater 31′ performs heating on the first lens 21′.

The temperature-sensing module 40′ is engaged with the heating module 30′ and is received in the recess 142′ of the lens barrel 10′. Referring to FIG. 12 and FIG. 13, the temperature-sensing module 40′ includes a plurality of thermister sensors 41′. The way of disposing the thermister sensors 41′ is that same as that of the first embodiment, i.e., the thermister sensors 41′ are engaged with the electro-thermal heater 31′ and are received in the receiving holes 1421′ of the recess 142′, wherein a gap is reserved between a periphery of each of the thermister sensors 41′ and each of the receiving holes 1421′, so that a peripheral surface of the thermister sensor 41′ is not in contact with an inner wall of the recess 142′, which could also achieve the purpose of reducing the effect of the thermal energy of the heating module 30 being dispersed.

The thermal insulating material 50′ encloses around the temperature-sensing module 40′ to be filled into the recess 142′, wherein the properties of the thermal insulating material 50′ are the same as that of the first embodiment, i.e., the thermal insulating material 50′ is a solid material, a gel layer, or a liquid material and a thermal conductivity coefficient of the thermal insulating material 50′ is less than or equal to 0.1 W/m.K for preventing the thermal energy of the heating module 30′ from being dispersed to the lens barrel 10.

Additionally, the structure and the disposing way of the lens restricting member 60′ and the lens cover 70′ are the same as that of the first embodiment and are not repeated here.

Moreover, the defogging lens barrel structure 200 of the second embodiment corresponds to the defogging lens barrel structure 100 of the first embodiment that the receiving holes 1421′ of the recess 142′ of the lens barrel 10′ are filled with the thermal insulating material 50′. At that time, the separating blocks 1422′ are adapted to respectively restrict the thermal insulating material 50′ in each of the receiving holes 1421′. When heating module 30′ is actually activated to perform heating, the thermal insulating material 50′ could similarly separate the temperature-sensing module 40′ from the inner wall of the recess 142′, so that the heating efficiency of the heating module 30′ concentrated on the first lens 21′ could be improved and fog generated on the first lens 21′ could be reduced, which also achieve the purpose of improving a definition of an image captured by the lens assembly 20′.

In order to demonstrate the purpose, the features, and the effect of the present invention, the defogging lens barrel structure of the first embodiment is used to conduct the following heating experiments and temperature analyses thereof are provided, wherein the heating experiments of the first lens are conducted on an experimental group and a control group.

A defogging lens barrel structure of the experimental group makes use of the defogging lens barrel structure 100 of the first embodiment, wherein the recess of the defogging lens barrel structure is filled by the thermal insulating material. In the current experiment, a thermal conductivity coefficient of the thermal insulating material of the experimental group is 0.1 W/m.K. A defogging lens barrel structure of the control group is basically the same as the defogging lens barrel structure of the experimental group, except that the recess of the defogging lens barrel structure of the control group is not filled by a thermal insulating material.

The heating experiments on the experimental group and the control group are to respectively heat the first lens of the experimental group and the first lens of the control group at the heat flux of 0.25 W/mm³ for 60 seconds at the temperature of −40° C., and temperature distribution images of the entire first lens of the experimental group and the control group are simultaneously observed.

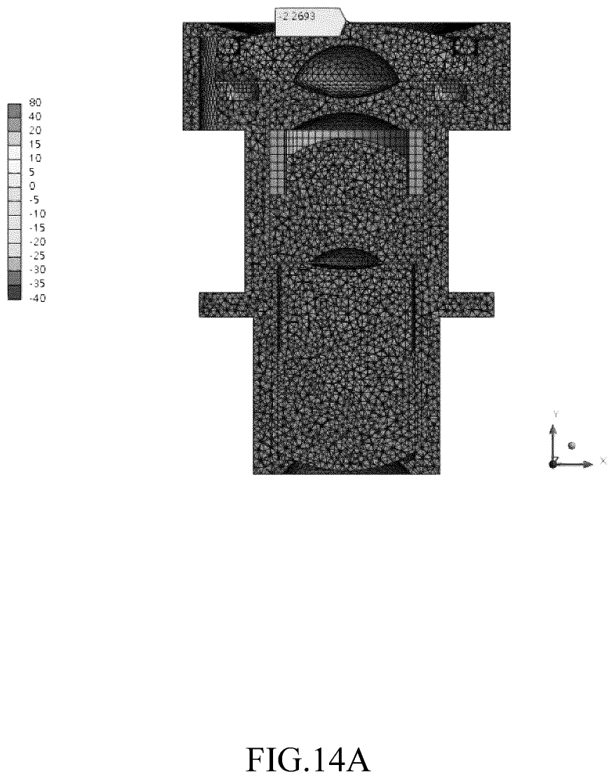

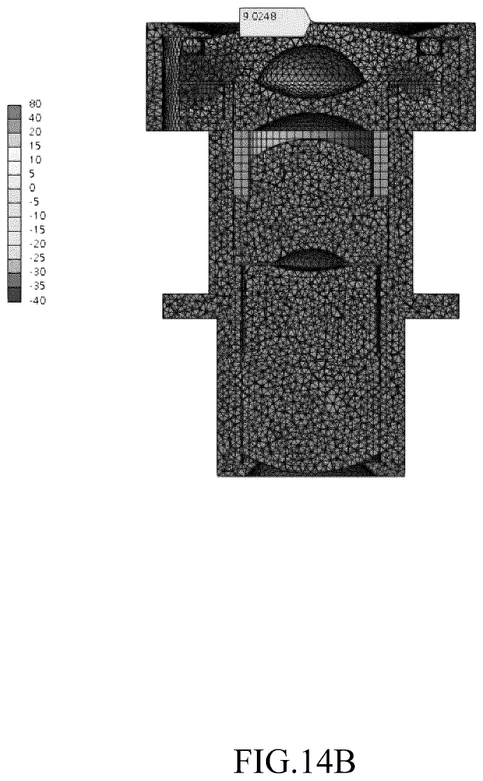

The heating experiment results are illustrated in FIG. 14A and FIG. 14B, wherein FIG. 14A shows the temperature distribution image of the control group, and FIG. 14B shows the temperature distribution image of the experimental group.

Referring to FIG. 14A, a heated region (regions with more intense color) of the first lens of the defogging lens barrel structure of the control group is mainly distributed around the peripheral portion, and a middle region of the first lens does not clearly show an increase in temperature due to heating (a middle of the object-side surface of the first lens of the control group is at −2.2693° C.). Referring to FIG. 14B, in comparison, a temperature of the entire first lens of the defogging lens barrel structure of the experimental group is clearly increased, and a heated region (regions with more intense color) of the peripheral portion of the first lens of the experimental group is larger than the heated region of the peripheral portion of the first lens of the control group (a middle of the object-side surface of the first lens of the of the control group is at 9.0248° C.).

With the aforementioned heating experiments, the thermal insulating material of the experimental group could reduce the effect of the thermal energy of the heating module being dispersed to the lens barrel, so that the heating efficiency of the heating module concentrated on the first lens is improved and the entire first lens is evenly heated, thereby improving the effect of defogging.

It must be pointed out that the embodiments described above are only some preferred embodiments of the present invention. All equivalent structures which employ the concepts disclosed in this specification and the appended claims should fall within the scope of the present invention.

What is claimed is:

1. A defogging lens barrel structure, comprising:
a lens barrel having a receiving groove, wherein an inner portion of the receiving groove includes an abutting surface and a recess disposed on the abutting surface;
a lens assembly disposed inside the lens barrel and comprising a first lens, wherein the first lens is disposed in the receiving groove and has a lens abutting surface correspondingly facing the abutting surface;
a heating module disposed between the abutting surface of the lens barrel and the lens abutting surface of the first lens and adapted to provide a heat source;
a temperature-sensing module engaged with the heating module and received in the recess of the lens barrel; and
a thermal insulating material enclosing around the temperature-sensing module to be filled into the recess, wherein the thermal insulating material is a solid material, a gel layer, or a liquid material; a thermal conductivity coefficient of the thermal insulating material is less than or equal to 0.1 W/m.K.

2. The defogging lens barrel structure as claimed in claim 1, wherein an axis is defined on the lens barrel; the lens barrel has an object-side opening communicating with the receiving groove along the axis; the abutting surface faces the object-side opening and is located on a bottom of the receiving groove; the first lens comprises a peripheral portion, wherein a side of the peripheral portion has the lens abutting surface and is disposed on the abutting surface.

3. The defogging lens barrel structure as claimed in claim 2, wherein the recess comprises a receiving hole facing the object-side opening and arranged on the abutting surface around the axis.

4. The defogging lens barrel structure as claimed in claim 2, wherein the recess comprises a plurality of receiving holes respectively facing the object-side opening and arranged at intervals on the abutting surface around the axis; the recess forms a separating block between adjacent two of the plurality of receiving holes.

5. The defogging lens barrel structure as claimed in claim 3, wherein the heating module comprises an electro-thermal heater correspondingly disposed on the abutting surface of the receiving groove around the axis and covering the recess; the lens abutting surface of the first lens abuts against the electro-thermal heater; the electro-thermal heater is connected to an external power source through a conducting wire to provide the heat source to the first lens.

6. The defogging lens barrel structure as claimed in claim 4, wherein the heating module comprises an electro-thermal heater correspondingly disposed on the abutting surface of the receiving groove around the axis and covering the recess; the lens abutting surface of the first lens abuts against the electro-thermal heater; the electro-thermal heater is connected to an external power source through a conducting wire to provide the heat source to the first lens.

7. The defogging lens barrel structure as claimed in claim 5, wherein the lens barrel comprises a side opening passing through the receiving groove, connected to the object-side opening, and adapted to be passed through by the conducting wire for being connected to the electro-thermal heater and to guide the conducting wire out of the lens barrel.

8. The defogging lens barrel structure as claimed in claim 6, wherein the lens barrel comprises a side opening passing through the receiving groove, connected to the object-side opening, and adapted to be passed through by the conducting wire for being connected to the electro-thermal heater and to guide the conducting wire out of the lens barrel.

9. The defogging lens barrel structure as claimed in claim 5, wherein the temperature-sensing module comprises at least one thermister sensor engaged with the electro-thermal heater and received in the recess; the thermal insulating material is filled into the recess and is in contact with the at least one thermister sensor and the electro-thermal heater.

10. The defogging lens barrel structure as claimed in claim 6, wherein the temperature-sensing module comprises at least one thermister sensor engaged with the electro-thermal heater and received in the recess; the thermal insulating material is filled into the recess and is in contact with the at least one thermister sensor and the electro-thermal heater.

11. The defogging lens barrel structure as claimed in claim 9, wherein when the thermal insulating material is the solid material, the thermal insulating material has at least one hole adapted to receive the at least one thermister sensor in the thermal insulating material.

12. The defogging lens barrel structure as claimed in claim 10, wherein when the thermal insulating material is the solid material, the thermal insulating material has at least one hole adapted to receive the at least one thermister sensor in the thermal insulating material.

13. The defogging lens barrel structure as claimed in claim 3, wherein the receiving hole comprises a large-diameter section and a small-diameter section; the large-diameter section is connected to the abutting surface; the small-diameter section is away from the abutting surface and is connected to the large-diameter section; the temperature-sensing module is correspondingly disposed in the large-diameter section; the thermal insulating material is correspondingly filled into the large-diameter section and the small-diameter section.

14. The defogging lens barrel structure as claimed in claim 4, wherein each of the plurality of receiving holes comprises a large-diameter section and a small-diameter section; the large-diameter section is connected to the abutting surface; the small-diameter section is away from the abutting surface and is connected to the large-diameter section; the temperature-sensing module is correspondingly disposed in the large-diameter section; the thermal insulating material is correspondingly filled into the large-diameter section and the small-diameter section.

15. The defogging lens barrel structure as claimed in claim 2, wherein the inner portion of the receiving groove comprises an inside wall connected to the abutting surface and the object-side opening; a thermal insulating portion is provided on the inside wall; the peripheral portion has an annular peripheral surface connected to the lens abutting surface and correspondingly facing the inside wall; the thermal insulating portion is in contact between the inside wall and the annular peripheral surface.

16. The defogging lens barrel structure as claimed in claim 2, further comprising a lens cover fitting around the lens barrel, wherein an end of the lens cover has a blocking ring partially covering the object-side opening; a side of the blocking ring facing the object-side opening has a thermal insulating ring; when an object-side surface of the first lens protrudes out of the object-side opening, the thermal insulating ring abuts against the object-side surface to be fixed between the object-side surface and the blocking ring.
